(19) United States
(12) Patent Application Publication
(10) Pub. No.: US 2023/0082924 A1
(43) Pub. Date: Mar. 16, 2023

(54) BATTERY PACK HOUSING, BATTERY PACK, AND ELECTRIC VEHICLE

(71) Applicant: BYD COMPANY LIMITED, SHENZHEN (CN)

(72) Inventors: Xiaopeng WANG, Shenzhen (CN); Qingbo PENG, Shenzhen (CN); Zhipei LU, Shenzhen (CN); Jianhua ZHU, Shenzhen (CN); Yan ZHU, Shenzhen (CN)

(21) Appl. No.: 17/989,608

(22) Filed: Nov. 17, 2022

Related U.S. Application Data
(63) Continuation of application No. PCT/CN2020/128117, filed on Nov. 11, 2020.

(30) Foreign Application Priority Data
May 22, 2020 (CN) 202010444233.6

(51) Int. Cl. H01M 50/112; H01M 50/242; H01M 50/383; H01M 10/6551; B60L 50/64; H01M 50/249

(52) U.S. Cl. CPC H01M 50/112; H01M 50/242; H01M 50/383; H01M 10/6551; B60L 50/64; H01M 50/249; H01M 2220/20

(57) ABSTRACT

A battery pack housing includes a housing body, the housing body includes multiple connected sub-housings, and at least one reinforcing plate is disposed in at least one of the sub-housings. Each of the sub-housings includes a top plate and a bottom plate arranged opposite to each other in a first direction, the first direction is a height direction of the housing, the at least one reinforcing plate is located between a top plate and a bottom plate, the at least one reinforcing plate is connected to the top plate and the bottom plate, and the at least one reinforcing plate divides an interior of the at least one of the sub-housings into multiple accommodating cavities. A mounting portion is provided on the housing and is configured to be connected and fixed to an external load.

### CROSS-REFERENCE TO RELATED APPLICATIONS

This application is a continuation application of International Patent Application No. PCT/CN2020/128117 filed with the China National Intellectual Property Administration (CNIPA) on Nov. 11, 2020, which is based on and claims priority to and benefits of Chinese Patent Application No. 202010444233.6 filed on May 22, 2020. The content of all of the above-identified applications is incorporated herein by reference in their entirety.

### FIELD

The present disclosure relates to the field of batteries, and specifically to a battery pack housing, a battery pack, and an electric vehicle.

### BACKGROUND

In the related art, a battery pack housing includes a tray and an upper cover connected to the tray, where the tray is usually formed by welding multiple side beams and a bottom plate. Moreover, as a main load-bearing component, the tray is generally welded with some reinforcing transverse and longitudinal beams inside the tray to ensure that the tray has a sufficient structural strength. As a result, the tray has too much components, and has a complex structure and a low space utilization rate. Moreover, the existing battery pack housing is relatively simple in structure and less versatile, which is adverse to the standardization, modularization and mass production of battery packs.

### SUMMARY

In a first aspect of the present disclosure, a battery pack housing is provided, which includes a housing body, the housing body includes multiple connected sub-housings, and at least one reinforcing plate is disposed in at least one of the sub-housings.

Each of the sub-housings includes a top plate and a bottom plate arranged opposite to each other in a first direction, the first direction is a height direction of the housing, the at least one reinforcing plate is located between a top plate and a bottom plate, the at least one reinforcing plate is connected to the top plate and the bottom plate, and the at least one reinforcing plate divides an interior of the at least one of the sub-housings into multiple accommodating cavities.

A mounting portion is provided on the housing and is configured to be connected and fixed to an external load.

In a second aspect of the present disclosure, a battery pack is provided, including a battery pack housing as described above.

In a third aspect of the present disclosure, an electric vehicle is provided, including a vehicle body and a battery pack as described above, where the battery pack is fixed to the vehicle body by the mounting portion.

The present disclosure has the following effects. The battery pack housing according to the present disclosure includes multiple connected sub-housings, and the number of the sub-housings can be configured according to the actual needs, to increases the flexibility and versatility in the design of the battery pack, and to facilitate the standardization, modularization and mass production of the battery pack. Moreover, in the present disclosure, the reinforcing plate is located between the top plate and the bottom plate, and the reinforcing plate is connected to the top plate and the bottom plate. Such a design allows the reinforcing plate, the top plate and the bottom plate to form an I-shaped structure. This structure has high strength and rigidity, so the battery pack housing has good load-bearing capacity, impact resistance, extrusion resistance, and other performances. Further, the battery pack housing according to the present disclosure has a simple structure, a low manufacturing cost, and a high space utilization rate. Furthermore, when this battery pack is mounted on a vehicle, the structural strength of the battery pack serves as part of the structural strength of the vehicle, to improve the structural strength of the vehicle, to meet the design requirement of a lightweight electric vehicle, and to reduce the design and manufacturing costs of the vehicle.

### BRIEF DESCRIPTION OF THE DRAWINGS

FIG. 1 is a schematic structural view of a battery pack provided in an embodiment of the present disclosure;

FIG. 2 is a schematic structural view of a battery pack housing provided in an embodiment of the present disclosure;

FIG. 3 is a partially enlarged view of part A in FIG. 2;

FIG. 4 is an exploded view of a battery pack housing provided in an embodiment of the present disclosure;

FIG. 5 is an exploded view of a battery pack housing provided in an embodiment of the present disclosure;

FIG. 6 is an exploded view of a battery pack housing provided in another embodiment of the present disclosure;

FIG. 7 is a schematic structural view of an anti-explosion valve provided in an embodiment of the present disclosure;

FIG. 8 is a schematic structural view of a sub-housing provided in an embodiment of the present disclosure;

FIG. 9 is a partially enlarged view of part B in FIG. 8;

FIG. 10 is a schematic structural view of another sub-housing provided in an embodiment of the present disclosure;

FIG. 11 is a partially enlarged view of part C in FIG. 10; and

FIG. 12 is a schematic structural view of an electric vehicle provided in an embodiment of the present disclosure.

### REFERENCE NUMERALS

battery pack 10;
housing 100; sub-housings 101; top plate 102; bottom plate 103; mounting portion 104; mounting hole 105; first side beam 106; second side beam 107; partition plate 108; connecting plate 109; Opening 110; end plate 111; adhesive injection hole 112; heat dissipation fin 113; flow channel 114; housing body 115; reinforcing plate 200;
accommodating cavity 300;
anti-explosion valve 400; protruding portion 401; cover 402; weak area 403;
electric vehicle 500.

### DETAILED DESCRIPTION

The following descriptions are some implementations of the present disclosure. It should be noted that a person of ordinary skill in the art may make certain improvements and polishing without departing from the principle of the present disclosure and the improvements and polishing shall fall within the protection scope of the present disclosure.

In the description of the present disclosure, it should be understood that the orientations or positional relationships indicated by the terms “length”, “width”, “upper”, “lower”, “front”, “rear”, “left”, “right”, “vertical”, “horizontal”, “top”, “bottom”, “inner”, “outer”, etc. are the orientations or positional relationships shown in the drawings, are merely to facilitate describing the present disclosure and to simplify the description, are do not indicate or imply that the referenced device or element must have a particular orientation, be constructed and operated in a particular orientation, and therefore do not limit the present disclosure.

In addition, terms “first” and “second” are used merely for the purpose of description, and do not indicate or imply relative importance or imply a quantity of indicated technical features. Therefore, a feature restricted by “first” or “second” may explicitly indicate or implicitly include one or more features. In description of the present disclosure, “multiple” means two or more than two, unless it is specifically defined otherwise.

In the present disclosure, unless otherwise explicitly specified or defined, the terms such as “mount”, “install”, “connect”, “connection”, and “fixed” should be understood in a broad sense. For example, the connection may be a fixed connection, a detachable connection, or an integral connection; or the connection may be a mechanical connection or an electrical connection; or the connection may be a direct connection, an indirect connection through an intermediary, or internal communication between two components or interaction between two components. A person of ordinary skill in the art may understand the specific meanings of the foregoing terms in the present disclosure according to specific situations.

Referring to FIGS. 1 to 4, a first embodiment of the present disclosure provides a battery pack housing 100. The housing 100 includes a housing body 115, and the housing body 115 includes multiple connected sub-housings 101. At least one sub-housing 101 is provided with at least one reinforcing plate 200 therein. The sub-housing 101 includes a top plate 102 and a bottom plate 103 arranged opposite to each other in a first direction, and the first direction is a height direction of the housing 100. The reinforcing plate 200 is located between the top plate 102 and the bottom plate 103, the at least one reinforcing plate 200 is connected to the top plate 102 and the bottom plate 103, and the at least one reinforcing plate 200 divides the interior of a corresponding sub-housing 101 into multiple accommodating cavities 300. A mounting portion 104 is provided on the housing 100, and the mounting portion 104 is configured to be connected and fixed to an external load. The first direction is the X direction in the figure.

The housing 100 of a battery pack 10 according to the present disclosure includes multiple connected sub-housings 101, and the number of the sub-housings 101 can be configured according to the actual needs, to increases the flexibility and versatility in the design of the battery pack 10, and to facilitate the standardization, modularization and mass production of the battery pack 10. Moreover, in the present disclosure, the reinforcing plate 200 is located between the top plate 102 and the bottom plate 103, and the reinforcing plate 200 is connected to the top plate 102 and the bottom plate 103. Such a design allows the reinforcing plate 200, the top plate 102 and the bottom plate 103 to form an I-shaped structure. This structure has high strength and rigidity, so the housing 100 of the battery pack 10 has good load-bearing capacity, impact resistance, extrusion resistance, and other performances. Moreover, the housing of the battery pack 10 according to the present disclosure has a simple structure, a low manufacturing cost, and a high space utilization rate. Furthermore, when this battery pack 10 is mounted on a vehicle, the structural strength of the battery pack 10 serves as part of the structural strength of the vehicle, to improve the structural strength of the vehicle, to meet the design requirement of a lightweight electric vehicle, and to reduce the design and manufacturing costs of the vehicle.

It should be noted that a mounting portion 104 is provided on the housing 100 of the battery pack 10 according to the present disclosure. The housing 100 of the battery pack 10 is detachably or non-detachably connected and fixed to an external load through the mounting portion 104 provided thereon. Generally, the housing 100 of the battery pack 10 needs to be fixedly connected to an external load, and thus has special requirements in terms of the impact resistance, extrusion resistance and other performances, so it shall not simply be equivalent to a casing 100 of a battery module or a cell. Generally, the battery pack 10 also includes at least one of a battery management system (BMS), a battery connector, a battery sampler and a battery thermal management system.

In addition, the reinforcing plate 200 is connected to the top plate 102 and the bottom plate 103. It can be understood that the reinforcing plate 200 may be formed integrally with the top plate 102 and the bottom plate 103; or the reinforcing plate 200, the top plate 102 and the bottom plate 103 are fabricated separately, and then connected directly or indirectly, which is not particularly limited in the present disclosure. In the direct connection, one end of the reinforcing plate 200 is connected to the bottom plate 103, and the other end of the reinforcing plate 200 is connected to the top plate 102. In the indirect connection, one end of the reinforcing plate 200 is connected to the bottom plate 103 via an intermediate plate, and the other end of the reinforcing plate 200 is connected to the top plate 102 via another intermediate plate.

In some embodiments, the at least one reinforcing plate 200 is connected to the top plate 102 and the bottom plate 103. It can be understood that the top plate 102, the bottom plate 103 and the reinforcing plate 200 are integrally formed; or one of the top plate 102 and the bottom plate 103 is integrally formed with the reinforcing plate 200, and the other is welded to the reinforcing plate 200; or one end of the reinforcing plate 200 is welded to the bottom plate 103, and the other end of the reinforcing plate 200 is welded to the top plate 102; or one end of the reinforcing plate 200 is welded to the bottom plate 103, and then the other end of the reinforcing plate 200 is welded to the top plate 102.

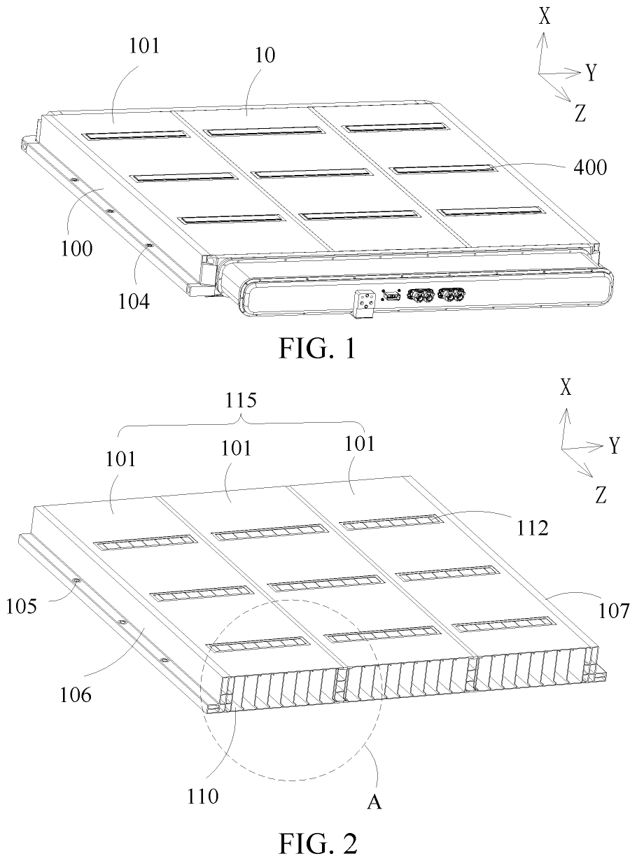

In an embodiment, as shown in FIG. 1 and FIG. 2, the housing 100 further includes a first side beam 106 and a second side beam 107 arranged or disposed at two opposite sides of the housing body 115 in a second direction, where the second direction is a width direction of the housing 100 or a length direction of the housing 100. The second direction is the Y direction in the figure.

In an embodiment, as shown in FIG. 4, the multiple sub-housings 101 are arranged in sequence along the second direction. Among the multiple sub-housings 101, the sub-housings 101 at two ends in the second direction are end sub-housings. One of the two end sub-housings is connected to the first side beam 106, and the other is connected to the second side beam 107. A first sub-housing 101 and a last sub-housing 101 in the Y direction in FIG. 4 are end sub-housings.

According to some embodiments of the present disclosure, the end sub-housing connected to the first side beam 106 is integrally formed with the first side beam 106, and the end sub-housing connected to the second side beam 107 is integrally formed with the second side beam 107. As such, this structure can not only simplify the processing process and reduce the cost, but also is ensured to have a sufficient structural strength.

In some embodiments, at least one of the top plate 102 and the bottom plate 103 of the end sub-housing connected to the first side beam 106 is integrally formed with the first side beam 106, and at least one of the top plate 102 and the bottom plate 103 of the end sub-housing connected to the second side beam 107 is integrally formed with the second side beam 107. For example, the structure is formed by extrusion with integrated aluminum profiles.

However, in other embodiments, the end sub-housing connected to the first side beam 106 is integrally formed with the first side beam 106, and the end sub-housing connected to the second side beam 107 is directly or indirectly connected to the second side beam 107. In an embodiment, the end sub-housing connected to the second side beam 107 is integrally formed with the second side beam 107, and the end sub-housing connected to the first side beam 106 is directly or indirectly connected to the first side beam 106.

In an embodiment, as shown in FIGS. 2 to 4, each of the first side beam 106 and the second side beam 107 has a cavity therein, and a partition plate 108 is provided in the cavity, where the partition plate 108 divides the cavity into multiple sub-cavities. Such a structure can ensure that the first side beam 106 and the second side beam 107 have a certain structural strength, to improve the impact resistance and anti-extrusion strength of the battery pack 10. However, in other embodiments, the first side beam 106 or the second side beam 107 has a cavity therein.

In an embodiment, as shown in FIGS. 2 to 4, the housing 100 further includes a connecting plate 109, where the connecting plate 109 is connected between two adjacent sub-housings 101. In the present disclosure, the connection mode is not particularly limited. It may be detachable connection, for example, by a bolt or a rivet; or non-detachable connection, for example, by welding or a gluing.

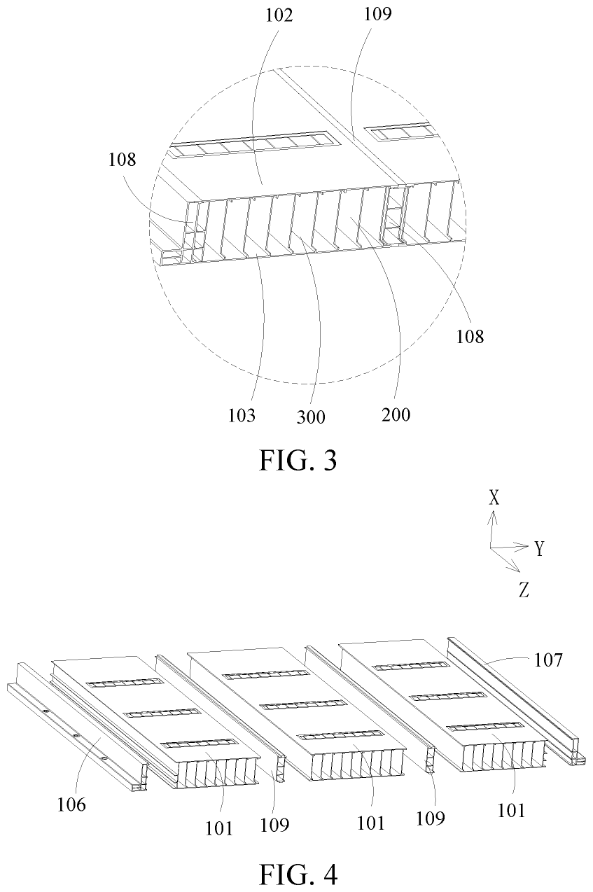

In an embodiment, as shown in FIG. 3, the connecting plate 109 has a cavity therein, and a partition plate 108 is provided in the cavity, where the partition plate 108 divides the cavity into multiple sub-cavities. Such a structure can increase the structural strength of the connecting plate 109, thereby improving the reliability of connection between two sub-housings 101.

In an embodiment, as shown in FIG. 2 and FIG. 3, the sub-housing 101 is provided with multiple reinforcing plates 200, and the multiple reinforcing plates 200 are arranged at intervals in the second direction. The length of each reinforcing plate 200 extends along a third direction, and each reinforcing plate 200 is connected to the top plate 102 and the bottom plate 103, where the first direction, the second direction, and the third direction are different. In this embodiment, each sub-housing 101 is provided with multiple reinforcing plates 200. In other embodiments, some of the sub-housings 101 are provided with multiple reinforcing plates 200 as desired in practice.

In the present disclosure, the first direction is the height direction of the housing 100, the second direction is the width direction of the housing 100, and the third direction is the length direction of the housing 100. In an embodiment, the second direction is the length direction of the housing 100, and the third direction is the width direction of the housing 100. The first direction is the X direction, the second direction is the Y direction, and the third direction is the Z direction in the figure.

However, in other embodiments, the first direction, the second direction, and the third direction may also be arranged at other angles with respect to each other, for example, 80° or 85°, which is not particularly limited in the present disclosure.

It should be noted that the reinforcing plate 200 is connected to the top plate 102 and the bottom plate 103. It can be understood that the reinforcing plate 200 may be formed integrally with the top plate 102 and the bottom plate 103. In an embodiment, the reinforcing plate 200, the top plate 102 and the bottom plate 103 are fabricated separately, and then connected directly or indirectly, which is not particularly limited in the present disclosure.

In some embodiments, at least one of the top plate 102 and the bottom plate 103 is integrally formed with the reinforcing plate 200. Such an arrangement has a simple processing process and reduces the production cost, and also ensures that the housing 100 has sufficient structural strength and rigidity, to meet the requirements of the housing 100 for load-bearing capacity, impact resistance, extrusion resistance, and other performances.

Specifically, the top plate 102, the bottom plate 103 and the reinforcing plate 200 are integrally formed. For example, the structure is formed by extrusion with integrated aluminum profiles. In another embodiment, the bottom plate 103 and the reinforcing plate 200 are integrally formed, and then the top plate 102 is welded to the reinforcing plate 200. In an embodiment, the top plate 102 and the reinforcing plate 200 are integrally formed, and then the bottom plate 103 is welded to the reinforcing plate 200.

It can be understood that when each reinforcing plate 200 is connected to the top plate 102 and the bottom plate 103, each reinforcing plate 200, together with the top plate 102 and the bottom plate 103, an I-shaped structure. Therefore, the housing 100 of the battery pack 10 has a general honeycomb structure. This structure has high strength and rigidity, to meet the requirements of the housing 100 for load-bearing capacity, impact resistance, extrusion resistance, and other performances. Moreover, the structure of the housing 100 is simple, and the space utilization rate is high. When this battery pack 10 is mounted on a vehicle, the structural strength of the battery pack 10 serves as part of the structural strength of the vehicle, to improve the structural strength of the vehicle, to meet the design requirement of a lightweight electric vehicle, and to reduce the design and manufacturing costs of the vehicle.

In a further embodiment, the first side beam 106 and the second side beam 107 are provided with a mounting portion 104, and the mounting portion 104 is configured to be connected and fixed to an external load.

In other embodiments, the mounting portion 104 may also be provided on the top plate 102 or the bottom plate 103.

In an embodiment, as shown in FIG. 1 and FIG. 2, the mounting portion 104 is a mounting hole 105 provided on the first side beam 106 and the second side beam 107. The mounting hole 105 is configured to allow a fastener (such as a bolt or a rivet) to penetrate through, to fixedly connect the battery pack 10 to an external load.

In some embodiments, the mounting hole 105 provided on the first side beam 106 penetrates the first side beam 106 in the first direction, and the mounting hole 105 provided on the second side beam 107 penetrates the second side beam 107 in the first direction. However, the axial direction of the mounting hole 105 may also be arranged at an angle with respect to the first direction, for example 5° or 10°.

According to some embodiments of the present disclosure, multiple mounting holes 105 are provided, and the mounting holes 105 provided on the first side beam 106 are arranged in sequence along the length direction of the first side beam 106. The length direction of the first side beam 106 is parallel to the third direction.

Similarly, the mounting holes 105 provided on the second side beam 107 are arranged in sequence along the length direction of the second side beam 107. The length direction of the second side beam 107 is parallel to the third direction.

In another embodiment, the mounting portion 104 is a ring provided on the first side beam 106 and the second side beam 107. The ring is fixedly connected to an external load, to fixedly connect the battery pack 10 to an external load.

In another embodiment, the mounting portion 104 is a mounting block provided on the first side beam 106 and the second side beam 107. The mounting block is fixed to an external load by welding. The mounting block can also be fixed to the external load by gluing or engaging.

According to some embodiments of the present disclosure, the length of the accommodating cavity 300 along the third direction is greater than 500 mm, or 500 mm-2500 mm. Such a design can accommodate more batteries or electrode core assemblies, to enable the battery pack 10 to meet the requirements of a high capacity and a high space utilization rate.

According to some embodiments of the present disclosure, the length of the accommodating cavity 300 along the third direction is 1000 mm-2000 mm, or 1300 mm-2200 mm.

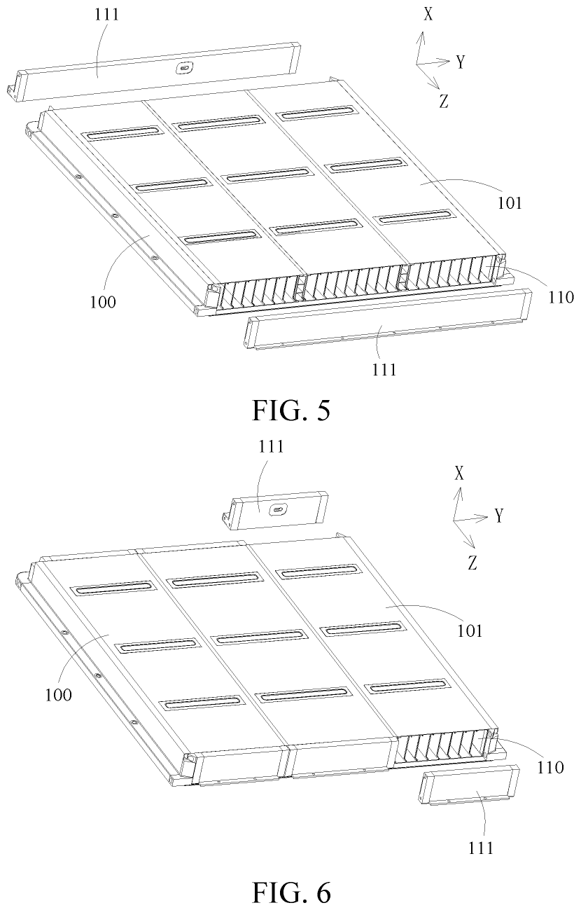

In some embodiments, as shown in FIG. 2, FIG. 5 and FIG. 6, the sub-housing 101 has a first end and a second end opposite to each other in the third direction, and the sub-housing 101 is provided with an opening 110 at at least one of the first end and the second. The housing 100 further includes an end plate 111 closing or sealing the opening 110. Each opening 110 corresponds to at least one end plate 111. Through such an arrangement, only the end plate 111 corresponding to the opening 110 of the sub-housings 101 needs to be removed in case of replacement or maintenance, so as to simplify the operation.

The mechanism of the end plate 111 sealing the opening 110 of the sub-housing 101 is not particularly limited. For example, the end plate 111 is welded to the sub-housing 101 to close the opening 110 of the sub-housing 101; or the end plate 111 is bonded to the sub-housing 101 to close the opening 110 of the sub-housing 101; or the end plate 111 is riveted or screwed to the sub-housing 101, and a gasket is provided between the end plate 111 and the sub-housing 101, to close the opening 110 of the sub-housing 101.

In this embodiment, both the first end and the second end of each sub-housing 101 are provided with openings 110, and the openings 110 correspond to both end plates 111 respectively. In other embodiments, each opening 110 may correspond to multiple end plates 111, that is, multiple end plates 111 close/seal one opening 110 of the sub-housing 101.

According to some embodiments of the present disclosure, as shown in FIG. 2 and FIG. 5, the multiple end plates 111 located at the same end of the housing body 115 in the third direction are an integrally formed piece. That is, the multiple end plates 111 located at the first end of the housing body 115 are a piece integrally formed; or the multiple end plates 111 located at the second end of the housing body 115 are a piece integrally formed; or the multiple end plates 111 located at the first end of the housing body 115 and the multiple end plates 111 located at the second end of the housing body 115 are pieces integrally formed. Such an arrangement can simplify the processing of the end plate 111, and reduce the cost.

In some embodiments, the battery pack housing 100 is a sealed housing 100, and the air pressure in the accommodating cavity 300 is lower than the air pressure outside the housing 100. Through such an arrangement, the air pressure in the accommodating cavity 300 is lower than air pressure outside the housing 100 by vacuuming. Therefore, moisture and other substances present in the housing 100 can be reduced, to prevent the long-term aging effect and damage of the moisture on/to the electrode core assembly, battery and other components in the housing 100, and to improve the service life of the battery pack 10. Furthermore, the sealed housing 100 also provides a double sealing effect.

In an embodiment, the pressure in the accommodating cavity 300 is −40 KPa to −70 KPa. Such an arrangement can ensure the reduction of moisture, oxygen, and other substances present in the housing 100, to prevent the long-term aging effect of the moisture and oxygen on the electrode core assembly and various components in the housing 100, and to improve the service life of the electrode core assembly and various components in the housing 100.

In an embodiment, the housing 100 is provided with a gas exhaust hole communicating with the accommodating cavity 300, via which the interior of the housing 100 can be vacuumed. Therefore, moisture and other substances present in the housing 100 can be reduced, to prevent the long-term aging effect and damage of the moisture on/to the battery or electrode core assembly and other components in the housing 100, and improve the service life of the battery pack 10.

In some embodiments, the housing 100 is provided with an adhesive injection hole 112 (as shown in FIG. 2), and each accommodating cavity 300 communicates with at least one corresponding adhesive injection hole 112. The adhesive injection hole 112 is configured to fill an adhesive into a corresponding accommodating cavity 300, to fixedly connect the electrode core assembly or battery arranged in the accommodating cavity 300 to the housing 100, and thus further improve the structural strength of the battery pack 10. In this embodiment, the adhesive injection hole 112 is provided on the top plate 102 of the sub-housing 101. In other embodiments, the adhesive injection hole 112 may also be provided on the bottom plate 103 of the sub-housing 101.

In some embodiments, as shown in FIG. 1 and FIG. 2, the housing 100 is provided with an anti-explosion valve 400, and the anti-explosion valve 400 covers, closes, or seals the adhesive injection hole 112. As such, the anti-explosion valve 400 can act as a sealing cover to seal the adhesive injection hole 112, and also to prevent explosion.

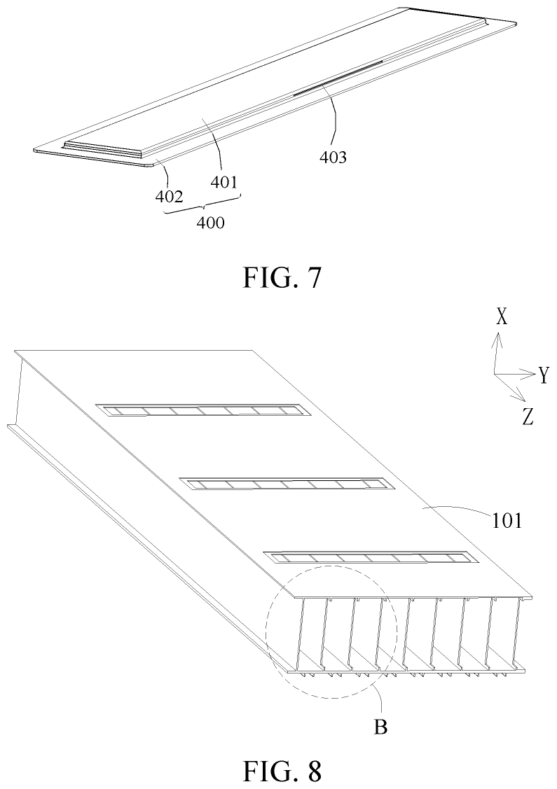

In some embodiments, as shown in FIG. 7, the anti-explosion valve 400 has a weak area 403 and a cover 402 hermetically connected to the housing 100, and a protruding portion 401 is provided on the cover 402. The protruding portion 401 protrudes toward a side away from the housing 100, and a weak area 403 is formed on an outer peripheral wall of the protruding portion 401. As such, when the electrode core assembly in battery pack 10 works abnormally and causes excessive gas production, the gas pressure may break the weak area 403 of the anti-explosion valve 400, to prevent the occurrence of safety incidents of the battery pack 10.

It should be noted that the weak area 403 may be a groove or a notch. In an embodiment, the thickness of the weak area 403 is lower than the thickness of other parts on the anti-explosion valve 400.

According to some embodiments of the present disclosure, the adhesive injection hole 112 is provided on the top plate 102, and the cover 402 is hermetically connected to the top plate 102. The mechanism of the hermetical connection is not particularly limited, for example, the hermetical connection can be achieved by welding or gluing.

In some embodiments, the anti-explosion valve 400 includes a cover 402 and a protruding portion 401 provided on the cover body 402. An edge of the cover 402 is connected to an inner wall of the adhesive injection hole 112, and the protruding portion 401 protrudes from the cover 402 toward a side away from the electrode core assembly.

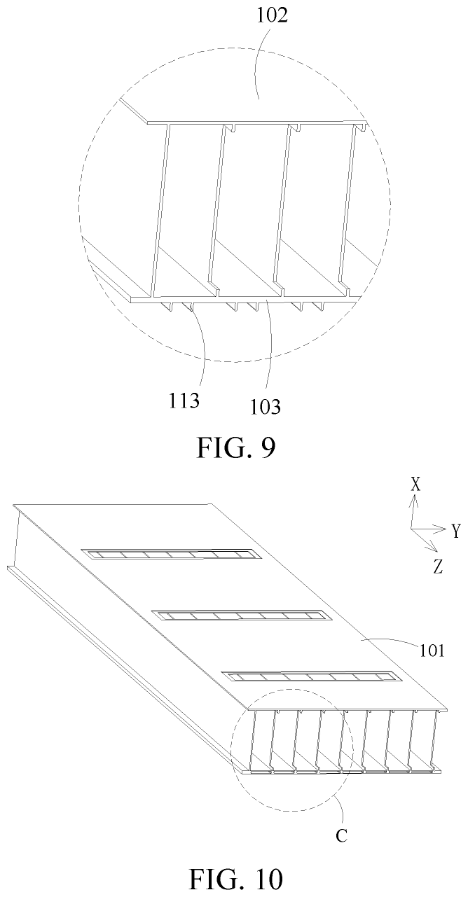

In some embodiments, as shown in FIG. 8 and FIG. 9, the bottom plate 103 is provided with a heat dissipation fin 113. According to some embodiments of the present disclosure, the heat dissipation fin 113 and the bottom plate 103 are integrally formed. For example, the bottom plate 103 is integral formed with the heat dissipation fin 113 by extrusion with integrated aluminum profiles. Such an arrangement can simplify the processing process and reduce the cost.

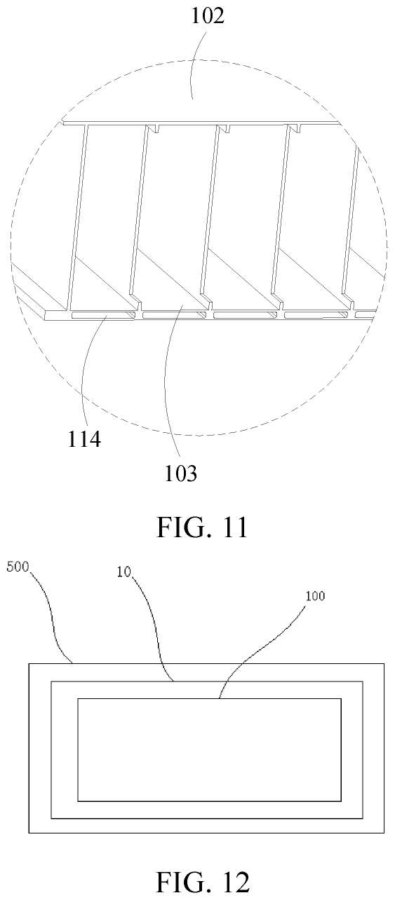

In some embodiments, as shown in FIG. 10 and FIG. 11, the bottom plate 103 is provided with a flow channel 114. According to some embodiments of the present disclosure, the flow channel 114 is integrally formed on the bottom plate 103. For example, the bottom plate 103 is formed integrally with the flow channel 114 by extrusion with integrated aluminum profiles. Such an arrangement can simplify the processing process and reduce the cost.

Moreover, the present disclosure further provides a battery pack 10, which includes a battery pack housing 100 as described above. The battery pack 10 according to the present disclosure has a battery pack housing 100 as described above, which increases the flexibility and versatility in the design of the battery pack 10, and facilitates the standardization, modularization and mass production of the battery pack 10. Moreover, the battery pack housing 100 has good load-bearing capacity, impact resistance and extrusion resistance, to allow the battery pack 10 to have a high structural strength.

In another aspect, the present disclosure further provides an electric vehicle 500 (see FIG. 12), which includes a vehicle body and a battery pack 10 mentioned above, where the battery pack 10 is fixed to the vehicle body by the mounting portion 104. In the electric vehicle 500 provided in the present disclosure, when the battery pack 10 is mounted on a vehicle, the structural strength of the battery pack 10 serves as part of the structural strength of the vehicle, to improve the structural strength of the vehicle, to meet the design requirement of a lightweight electric vehicle, and to reduce the design and manufacturing costs of the vehicle. In addition, the battery pack 10 according to the present disclosure has a relatively low height, and does not occupy too much space in the height of the vehicle.

The foregoing embodiments are only several implementations of the present disclosure described in detail, but do not limit the scope of the present disclosure. It should be noted that a person of ordinary skill in the art may further make several variations and improvements without departing from the idea of the present disclosure, and the variations and improvements all fall within the protection scope of the present disclosure. Therefore, the protection scope of the present disclosure shall be subject to the appended claims.

What is claimed is:

1. A battery pack housing, comprising a housing body, wherein
the housing body comprises a plurality of connected sub-housings, and at least one reinforcing plate is disposed in at least one of the sub-housings;
each of the sub-housings comprises a top plate and a bottom plate arranged opposite to each other in a first direction, the first direction is a height direction of the housing, the at least one reinforcing plate is located between a top plate and a bottom plate, the at least one reinforcing plate is connected to the top plate and the bottom plate, and the at least one reinforcing plate divides an interior of the at least one of the sub-housings into a plurality of accommodating cavities; and
a mounting portion is provided on the housing and is configured to be connected and fixed to an external load.

2. The battery pack housing according to claim 1, further comprising a first side beam and a second side beam arranged at two opposite sides of the housing body in a second direction, wherein the second direction is a width direction or a length direction of the housing.

3. The battery pack housing according to claim 2, wherein the sub-housings are arranged along the second direction, two end sub-housings are at two ends of the sub-housings in the second direction, a first end sub-housing of the two end sub-housings is connected to the first side beam, and a second end sub-housing of the two end sub-housings is connected to the second side beam.

4. The battery pack housing according to claim 3, wherein
the first end sub-housing is integrally formed with the first side beam; or
the second end sub-housing is integrally formed with the second side beam; or
the first end sub-housing is integrally formed with the first side beam and the second end sub-housing is integrally formed with the second side beam.

5. The battery pack housing according to claim 2, wherein at least one of the first side beam and the second side beam has a cavity, a partition plate is provided in the cavity, and the partition plate divides the cavity into a plurality of sub-cavities.

6. The battery pack housing according to claim 1, wherein the housing body further comprises a connecting plate connected between two adjacent sub-housings.

7. The battery pack housing according to claim 6, wherein the connecting plate has a cavity, a partition plate is provided in the cavity, and the partition plate divides the cavity into a plurality of sub-cavities.

8. The battery pack housing according to claim 1, wherein
a plurality of reinforcing plates are provided in the at least one of the sub-housings,
the plurality of reinforcing plates are arranged at intervals in a second direction,
a length of each of the reinforcing plates extends along a third direction,
each of the reinforcing plates is connected to the top plate and the bottom plate, and
the second direction is a width direction of the housing, and the third direction is a length direction of the housing; or the second direction is the length direction of the housing, and the third direction is the width direction of the housing.

9. The battery pack housing according to claim 8, wherein at least one of the top plate and the bottom plate is integrally formed with the reinforcing plates.

10. The battery pack housing according to claim 1, wherein a length of an accommodating cavity of the plurality of accommodating cavities along a third direction is greater than 500 mm, and the third direction is a length direction or a width direction of the housing.

11. The battery pack housing according to claim 1, wherein
each of the sub-housings has a first end and a second end opposite to each other in a third direction, and at least one of the first end and the second end has an opening,
the housing further comprises at least an end plate covering a corresponding opening, and
the third direction is a length direction or a width direction of the housing.

12. The battery pack housing according to claim 11, wherein a plurality of end plates located at a same end of the housing body in the third direction are integrally formed.

13. The battery pack housing according to claim 1, wherein the housing comprises at least one adhesive injection hole, and each of the accommodating cavities communicates with at least one corresponding adhesive injection hole.

14. The battery pack housing according to claim 13, wherein the housing comprises an anti-explosion valve, and the anti-explosion valve seals the at least one adhesive injection hole.

15. The battery pack housing according to claim 14, wherein
the anti-explosion valve has a weak area; and
the anti-explosion valve comprises a cover sealed with and connected to the housing and a protruding portion on the cover, the protruding portion protrudes away from the housing, and the weak area is formed on an outer peripheral wall of the protruding portion.

16. The battery pack housing according to claim 1, wherein the bottom plate is provided with a flow channel communicating with an exterior of the housing.

17. The battery pack housing according to claim 1, wherein the bottom plate is provided with a heat dissipation fin.

18. The battery pack housing according to claim 1, further comprising a first side beam and a second side beam arranged at two opposite sides of the housing body in a second direction, wherein
a plurality of reinforcing plates are provided in each of the sub-housings, the reinforcing plates are arranged at intervals in the second direction, a length of each of the reinforcing plates extends along a third direction, each of the reinforcing plates is connected to the top plate and the bottom plate, and at least one of the top plate and the bottom plate is integrally formed with the reinforcing plates,
each of the sub-housings has a first end and a second end opposite to each other in the third direction, both the first end and the second end comprise an opening, and the housing further comprises end plates covering openings, and
the second direction is a width direction of the housing, and the third direction is a length direction of the housing; or the second direction is the length direction of the housing, and the third direction is the width direction of the housing.

19. A battery pack, comprising a battery pack housing comprising a housing body, wherein
the housing body comprises a plurality of connected sub-housings, and at least one reinforcing plate is disposed in at least one of the sub-housings;
each of the sub-housings comprises a top plate and a bottom plate arranged opposite to each other in a first direction, the first direction is a height direction of the housing, the at least one reinforcing plate is located between a top plate and a bottom plate, the at least one reinforcing plate is connected to the top plate and the bottom plate, and the at least one reinforcing plate divides an interior of the at least one of the sub-housings into a plurality of accommodating cavities; and
a mounting portion is provided on the housing and is configured to be connected and fixed to an external load.

20. An electric vehicle, comprising a vehicle body and a battery pack, wherein the battery pack comprises a battery pack housing comprising a housing body, and wherein
the housing body comprises a plurality of connected sub-housings, and at least one reinforcing plate is disposed in at least one of the sub-housings;
each of the sub-housings comprises a top plate and a bottom plate arranged opposite to each other in a first direction, the first direction is a height direction of the housing, the at least one reinforcing plate is located between a top plate and a bottom plate, the at least one reinforcing plate is connected to the top plate and the bottom plate, and the at least one reinforcing plate divides an interior of the at least one of the sub-housings into a plurality of accommodating cavities;
a mounting portion is provided on the housing and is configured to be connected and fixed to an external load; and
the battery pack is fixed to the vehicle body by the mounting portion.
